(19) United States
(12) Patent Application Publication
(10) Pub. No.: US 2003/0050793 A1
(43) Pub. Date: Mar. 13, 2003

(54) Method for monitoring payments for vehicle parking services

(76) Inventor: Pierre-Yves Lejeune, Paris (FR)

Correspondence Address: RATNERPRESTIA, P O BOX 980, VALLEY FORGE, PA, 19482-0980, US

(21) Appl. No.: 10/239,726

(22) PCT Filed: Mar. 13, 2001
(86) PCT No.: PCT/FR01/00732

(30) Foreign Application Priority Data
Mar. 27, 2000 (FR) 00 03842

(51) Int. Cl. G06F 17/60

(52) U.S. Cl. 705/1; 705/41

(57) ABSTRACT

This invention relates to a method for paying and allocating the tax for parking vehicles.

The method comprises:

Storing parking policies in a display (1),

selecting (1b) the parking policy of the city where the vehicle is parked,

displaying (1c) a code corresponding to the parking place, as well as the data enabling the parking management services to check whether the vehicle is parked in compliance with the specified parking policy,

calculating (1a) the amount of tax depending on the parking time,

storing (1d) the amount in the display (1),

collecting, by means of a dedicated server (5), the amount of said tax and allocating the worth thereof to the revenue account of the city.

Thus, the driver (3) is debited only of the amount of tax corresponding to the parking time.

The motorist parking on the street or in a car park wishes to be able to pay the parking charges for his vehicle rapidly and ergonomically. In particular, the user parking on the street wishes to be able to pay the parking tax for his vehicle rapidly and ergonomically, without having to leave the vehicle and without having to know or look up the parking policy (residential rates, non residential rates, time slots, etc.) specific to the town he is stopping in.

Moreover, he wishes the tax to be calculated depending on the actual parking time, without having to predetermine it himself and time the parking time he has at his disposal, while his mind is busy with his own business.

As for the administration of public thoroughfares, they wish to be able to check quickly and economically that the tax to be paid is actually being paid by the motorists. The Treasury and the administration of public thoroughfares wish to check that the tax paid will actually be allocated to the revenue budget of the town where the motorist is parking.

This is the problem posed for which this invention offers a solution, as will be demonstrated below.

It is known to pay street parking tax by means of pocket calculators integrated in the motorist's vehicle. This mainly involves the S-card and the Piaf.

The S-card comes in the form of a multipurpose card substantially of credit card size. It includes a keypad the motorist uses for programming a microprocessor according to data relating to the parking policy of the town or district of the town where he is parking. The S-card also includes a viewing screen that the administration of public thoroughfares can use to check whether the vehicle is in a lawful position.

The user neither has to leave the vehicle to take a ticket at the parking ticket machine nor does he have to predetermine his parking time. When he parks his car, he activates the S-card, which deducts the time elapsed, and, when he leaves again, he deactivates the S-card. Therefore, he only pays for the parking actually consumed.

The motorist buys the S-card from the authorized outlets of the cities, which have approved it.

As sophisticated as it may be, the S-card has various disadvantages. On the one hand, it requires a cross-subsidization almost impossible to implement in order to allocate the parking tax of the vehicles parking there to the revenue budget of the town involved. On the other hand, each time the motorist parks in another rating area, he must program the parking policy parameters by means of the keypad. And yet, he can only do so if he is aware of this policy, which is rarely the case.

Therefore, the S-card does not solve the problem outlined above.

The Piaf is composed, on the one hand, of a multipurpose box comprising a calculation means (a microprocessor) and a display (LCD-type) and, on the other hand, a set of cards (phonecard-type) which are preprogrammed according to the specific parking policy of each town.

The motorist buys the multipurpose box and the cards, in particular from the authorized outlets of the town that have approved it.

The motorist uses the Piaf in the same way he uses the S-card. Therefore, he does not have to leave the vehicle to pay the parking tax. He only pays for parking actually consumed.

Also, the revenue related to card sales can be allocated directly to the budget of the cities that have issued them.

However, the Piaf has various disadvantages. On the one hand, it is relatively expensive as the motorist has to buy the box and the set of cards specific to the cities where he uses to park. On the other hand, a motorist stopping in a town has to find the points of sale of the town specific cards. Finally, when a town modifies its parking policy, the motorist has to replace his parking cards.

This invention overcomes the disadvantages outlined above.

### Method

The present invention relates to a method of paying and allocating the charges for parking vehicles to service providers, in particular service providers offering a parking service in an open space, for example on the street in a town, and/or service providers offering parking facilities in an enclosed space, for example a car-park. The vehicles are used by motorists possessing control units. The control units comprise information representing a pre-paid amount for parking services and/or authorization for parking services.

The method comprises the step for activating the control unit at the beginning and at the end of the parking period. Preferably, the control unit is activated by the motorist, more particularly in the case of parking in the street. However, in the case of parking in a car-park the unit can be activated by signals emitted by terminals situated at the entrance or the exit of the car-park and detecting the presence of the vehicle.

The method also comprises the step for calculating the amount of the parking charges depending on the length of parking time.

The method also comprises the step of storing the amount in a memory area, in particular in a memory area of the control unit.

The method also comprises the step for collecting the amount for the parking service by means of a dedicated server and of allotting this sum to the service provider of the parking concerned.

### The Method According to the Invention in the Case of Parking in the Street

In a first embodiment of the invention, the method is more particularly intended for payment and allocation of parking taxes for vehicles, especially in the street. The parking policies of the cities involved, in particular the rate per hour according to the parking areas and/or the free time and/or the maximum admissible time, are predetermined.

The method, according to the invention, comprises the step of storing all or part of said parking policies in a memory located in a control unit on-board said vehicle.

The method further comprises the step of selecting, by means of a control member of the control unit, in particular a control member activating a drop-down menu, the parking policy of the town where the vehicle is parked and, in case the parking policy varies depending on the parking area, the parameters specific to said parking area.

The method further comprises the step of displaying, by the control unit, a code corresponding to the parking place, in particular the name of the town, as well as the data enabling the parking management services to check whether the vehicle is parked in compliance with the specified parking policy.

The method further comprises the step of activating the control unit at the beginning of the parking period and deactivating the control unit at the end of the parking period.

The method further comprises the step of calculating the amount of the parking tax depending on the parking time.

The method further comprises the step of storing the amount in a storage area of the control unit.

The method further comprises the step of collecting the amount of tax, by means of a dedicated server, and allocating the worth thereof to the revenue account of the town where the vehicle is parked.

Thus, only the amount of tax corresponding to the parking time is debited to the driver of the vehicle. This amount is allocated to town concerned.

Preferably, the control unit is switched on and off manually.

Preferably, the method according to the invention comprises the step of deducting the amount of said tax from an electronic purse contained in said control unit.

Preferably, the electronic purse is removable.

Preferably, to refill the electronic purse the method comprises several steps.

It comprises the memorization step, in a storage area of a transfer card, of data corresponding to a credited sum.

In addition, it comprises the step of connecting, via connecting means in particular contactless, the transfer card to the electronic purse of the control unit.

It further comprises the step of transferring to the electronic purse of the control unit, via connecting means, data in particular reloading account units. The transfer of account units is managed in particular by means of a microprocessor.

Preferably, the method according to the invention further comprises the step of periodically connecting the control unit to the server to collect the amount of tax.

Preferably, the method according to the invention further comprises the step of periodically connecting the control unit to the server or another server for downloading the parking policies and/or modifications thereof.

Preferably, the method according to the invention further comprises the step of connecting the control unit to the server or another server for downloading the electronic purse having an amount agreed upon.

Preferably, the server, or another server, manages a user-account credited, in particular by cheque, transfer, electronic payment carried out via a communication network, especially of the Internet type. The server, or another server, deducts from the user-account the appropriate amount downloaded in the electronic purse.

For periodically connecting said control unit to said server or said other server, preferably, the method according to the invention comprises the step of setting up a telephone, radiotelephone or Internet-type link, between the control unit and the server.

To set up the link, the method according to the invention preferably comprises the step of sending acoustic signals, in particular of DTMF-type, between the control unit and a telephone unit, in particular a mobile phone, connected to the server via a telephone and/or computer communication network.

Thus, from within the vehicle, the motorist can use a mobile phone to connect the on-board control unit to the dedicated server.

### The Method According to the Invention in the Case of Parking in a Car-Park

In a second embodiment of the invention, which can be considered separately or in combination with the first embodiment variant, the method is more particularly aimed at the payment and allocation to the service providers, of the charges for parking services of vehicles in an enclosed space. Parking services are offered in particular in a car-park. The car-park comprises an entry barrier and an exit barrier. The method comprises several steps.

The method comprises the step, for the motorist entering the car-park, of emitting, to a receiver situated before the entry barrier, a first identification signal by means of the control unit. The first signal received by the receiver activates the opening of the entry barrier. The motorist can then park his vehicle.

The method further comprises the step, for the receiver, of transmitting the first signal to a control center.

The method further comprises the step, for the motorist leaving the parking, of emitting to a transponder located before the exit barrier, a second identification signal by means of the control unit.

The method further comprises the step, for the transponder, to transmit the second signal to the control center.

The method further comprises the step, for the control center, to determine, from the first and second identification signals, the dates of entry and exit, and the times of entry and exit of the vehicle.

The method further comprises the step, for the control center, to calculate the charge due by the motorist for the parking service depending on the length of parking time in the car-park.

The method further comprises the step, for the control center, to store the charges due by the motorist for the parking service.

The method further comprises the step, for the control center, to transmit the due sums for the parking service to the control unit, via the transponder.

The method further comprises the step, for the control unit, to deduct the charges for the parking service from an electronic purse contained in the control unit.

The method further comprises the step for the control unit to emit, after deduction of the due sums for the parking service from the electronic purse, a signal to the transponder to open the exit barrier. The motorist can then drive his vehicle out of the car-park.

The method further comprises a step, for the control center, to transmit to the server, via a telephone or computer communication network, the data concerning all the parking used, in said car-park, during a certain period of time. The server can then proceed with allocating the receipts for each car-park.

In the case of the embodiment described above, it is the motorist who, by means of the control unit (by operating it manually or vocally), produces the emission from the control unit, of the first identification signal and the second identification signal respectively, at the moment of entry and exit of the vehicle. In another embodiment of the invention, the emission of the first identification signal and the second identification signal, from the control unit, can be activated by signals from the terminals located at the entrance and exit of the car-park and detecting the presence of the vehicle. In this latter embodiment, the motorist has no need to intervene, the entry and exit barriers open automatically after detection of the vehicle and emission of the first identification signal and the second identification signal from the control unit.

### System

The invention also relates to a system for paying and allocating service providers with the due sums for parking services for vehicles, in particular service providers offering a parking service in an open space, for example in the street in town, and/or service providers offering a parking service in an enclosed space, for example a car-park. The vehicles are used by motorists with control units, comprising information representing a prepaid quantity of parking services and/or authorization for parking services. The control units comprises a control device, especially a keypad, which can be operated by the motorist at the beginning and end of the parking time.

The system comprises means of calculation to calculate the charges for the parking service depending on the length of parking.

The system further comprises memorization means to memorize the charge in a storage area.

The system further comprises remote data collection means for a dedicated server to collect the sums due for the parking service and to allocate this amount to the service provider of the parking concerned.

As already mentioned above, preferably the control unit is activated by the motorist, especially in the case of parking in the street. However, in the case of parking in a car-park, the unit can be activated by signals emitted by the terminals located at the entry or exit of the car-park, detecting the presence of the vehicle.

### System According to the Invention in the Case of Parking in the Street

In a first embodiment of the invention, the system is aimed in particular at paying and allocating the tax for parking vehicles, especially in the street. The parking policies of the cities involved, in particular the rate per hour according to the parking areas and/or the free time and/or the maximum admissible time, are predetermined.

The system, according to the invention, comprises a control unit on-board the vehicle.

The control unit comprises a storage means for storing parking policies in a memory.

The display further comprises a control member, in particular a keypad activating a drop-down menu.

The display control device is used for selecting the parking policy of the town where the vehicle is parked, and, in case the parking policy varies depending on the parking area, the parameters specific to said parking area.

The display control member is furthermore used for switching the control unit on at the beginning of the parking period and switching it off at the end of the parking period.

The control unit further comprises a display screen for displaying a code corresponding to the parking place, in particular the name of the town, as well as the data enabling the parking management services to check whether the vehicle is parked in compliance with the specified parking policy.

The control unit further comprises a microprocessor for calculating the amount of parking tax depending on the parking time and storing the amount in a storage area of the control unit.

The system, according to the invention, further comprises a dedicated server for periodically collecting the amount of tax and allocating this sum to the revenue account of the town where the vehicle is parked.

Thus, only the amount of tax corresponding to the parking time is debited to the driver of the vehicle. This amount is allocated to the town concerned.

Preferably, the microprocessor deducts the amount of tax from an electronic purse contained in the control unit.

Preferably, the electronic purse is located in a removable part of the control unit, in particular in the control unit lid.

Preferably, the system according to the invention further comprises one or more dedicated servers for downloading the parking policies and/or modifications thereof and/or for downloading the electronic purse having an amount agreed upon.

Preferably, the control unit and the servers are connected, via a telephone or computer communication network, in particular of Internet-type.

Thus, it can periodically collect the amount of parking tax stored in the control unit and allocate this sum to the revenue account of the town where the vehicle is parked.

Furthermore, it is possible to download the parking policies and/or modifications thereof into the memory of said control unit.

Furthermore, it is possible to refill the electronic purse.

Preferably, the system further comprises a transmission means for sending acoustic signals, in particular of DTMF-type, between the control unit and a telephone unit, in particular a mobile phone, connected to the servers via a telephone and/or computer communication network.

Thus, from inside the vehicle, the motorist can use a mobile phone to connect the on-board control unit to the dedicated servers.

Preferably, the control unit is integrated in an element of the vehicle. The control unit can in particular be installed on the rear face of the central driving mirror of the vehicle, on the rear face of a sun visor or on the dashboard of the vehicle.

The display screen of the control unit is turned towards the outside of the vehicle. The parking management services can thus verify whether the vehicle is parked in compliance with the set parking policy.

Preferably, the control unit components, in particular the microprocessor, memory, and display screen, are powered by a battery and/or a solar cell.

Preferably, the control unit is powered by electrical energy from the battery of the vehicle.

### System According to the Invention in the Case of Parking in a Car-Park

In a second embodiment of the invention, which can be considered separately or in combination with the first embodiment, the system is aimed more particularly at paying and allocating the vehicle parking charges to the service providers. The parking services are provided in an enclosed space, especially in a car-park.

The system comprises at least one entry barrier and at least one exit barrier situated respectively at the entry and exit of the enclosed car-park.

The system further comprises at least one receiver to receive signals, situated at each entry to the enclosed car-park, before the entry barrier.

The system further comprises at least one transponder emitting and receiving signals, situated at each exit from the car-park, before the exit barrier.

The control unit comprises means for emission and reception to emit a first identification signal to the receiver when the vehicle enters the car-park.

The control unit further comprises means of emission and reception to emit a second identification signal to the transponder, when the vehicle leaves the car-park.

The control unit further comprises a control device, in particular a keypad, to activate the emission of the first and second signal by means of emission and reception. As seen above, in the description of a variant of the embodiment of the method according to the invention, the control unit can be activated by signals from the terminals located at the entry and exit of the car-park.

The first signal received by the receiver activates the opening of the entry barrier. The motorists can then park his vehicle.

The system further comprises a control center, connected to the receiver and the transponder, receiving the first signal and the second signal.

The control center comprises processing means for determining, from the first and second identification signals, the dates of entry and exit, and the times of entry and exit of the vehicle.

The control center further comprises calculation means for calculating the charges due by the motorist for the parking service, depending on the length of parking in the car-park.

The control center further comprises memorization means for storing the charges due by the motorist for the parking service.

The control center further comprises transmission means for transmitting the sum due for the parking service to the means of emission and reception of the control unit, via the transponder.

The control unit further comprises an electronic purse.

The control unit further comprises a microprocessor comprising means for deducting the sum due to the parking service from the electronic purse.

The means of emission and reception of the control unit emit a signal for opening the exit barrier, towards the transponder, after deduction of the sum due for the parking service from the electronic purse. The motorist can then drive his vehicle from the car-park.

The control center transmits to the server, via a telephone or computer communication network, data related to the overall parking in the car-park, during a certain time period. The server can then proceed with allocating the receipts for each car-park.

### Server

The invention also relates to a server to be implemented to pay and allocate the service providers with the charges due for parking services for vehicles, in particular service providers offering a parking service in an open space, for example in the street of a town, and/or service providers offering a parking service in an enclosed space, for example a car-park. The vehicles are used by motorists with control units, comprising information representing a prepaid quantity of parking and/or authorization for parking services. The control units comprise a control device, in particular a keypad, which can be activated by the motorist at the beginning and the end of the parking time. Thus, as seen above, in the description of a variant of embodiment of the method according to the invention, the control unit can be activated by signals from the terminals located at the entry and exit of the car-park.

The server comprises remote data collection means to collect the charges for a parking service and means for allocating the amount to the service provider of the parking concerned. The parking charges are calculated in function of the length of parking time and stored in a memory area.

### The Server According to the Invention in the Case of Parking in the Street

In a first variant of embodiment of the server, the system is especially aimed at paying and allocating the taxes for parking vehicles, especially in the street. The parking policies of the cities involved, in particular the rate per hour according to the parking areas and/or the free time and/or the maximum admissible time, are predetermined. The tax is calculated by displays on-board the vehicles.

The server, according to the invention, comprises a storage means for storing parking policies in a memory.

The server further comprises a remote collecting means for collecting the amount of tax from each control unit, and/or downloading means for downloading parking policies into each control unit.

The server further comprises a calculation means for calculating the sum to be allocated to the revenue account of the town under consideration where the vehicle is parked.

Preferably, the server, according to the invention, comprises a connecting means for periodically connecting the server to the displays, via a telephone or computer communication network, in particular of Internet-type.

Preferably, the server further comprises a downloading means for downloading the parking policies and/or modifications thereof into a memory of said control unit.

### The Server According to the Invention in the Case of Parking in a Car-Park

In a second variant of embodiment of the server, which can be considered separately or in combination with the first variant of the embodiment, the server is more particularly intended to payment and allocation, to the service providers, of the charges for vehicle parking services. The parking services are in an enclosed space, especially in a car-park. The car-park is closed by at least one entry barrier and at least one exit barrier. The barriers are located respectively at the entry and the exit of the car-park. The motorist activates the barriers, at the entry and exit of the vehicle, by means of a control unit.

As seen above, in the description of a variant of the embodiment of the method according to the invention, the control unit can be activated by signals from terminals located at the entry and the exit of the car-park. In the case of this variant, the opening of the barriers is automatic, the motorist does not have to intervene.

The server is connected via a telephone or computer communication network to control centers associated to the car-parks. The server receives from each control center the data relating to the overall parking in the car-park concerned, over a certain time period. The control centers comprise calculation means for calculating the charges due for the parking service from each motorist depending on the time of parking in the car-park concerned. The time of parking is determined from signals emitted by the control unit at entry and at exit of each vehicle for the car-park. The signals are transmitted to the control center.

### Control Unit

The invention also relates to a control unit to be integrated into a vehicle for paying and allocating the tax for parking vehicles, especially in the street. The parking policies of the cities involved, in particular the rate per hour according to the parking areas and/or the free time and/or the maximum admissible time, are predetermined.

The control unit, according to the invention, comprises a storage means for storing the parking policies in a memory.

The control unit further comprises a control device, in particular a keypad activating a drop-down menu.

The control unit control member is for selecting the parking policy of the town where the vehicle is parked, and, in case the parking policy varies depending on the parking area, the parameters specific to said parking area.

The control unit control member is furthermore for activating the control unit at the beginning of the parking period and deactivating at the end of the parking period.

The control unit further comprises a display screen for displaying a code corresponding to the parking place, in particular the name of the town, as well as the data enabling the parking management services to check whether the vehicle is parked in compliance with the specified parking policy.

The control unit further comprises a microprocessor for calculating the amount of the parking tax depending on the parking time and for storing the amount in a storage area of the display.

The control unit further comprises a connecting means for connecting the control unit to one or more remote dedicated servers for (i) collecting the amount of tax and allocating the sum due to the revenue account of the town where the vehicle is parked and/or (ii) downloading the parking policies and/or modifications thereof and/or (iii) refilling the electronic purse.

Preferably, the microprocessor deducts the amount of tax from an electronic purse contained in the control unit.

Preferably, the electronic purse is located in a removable part of the control unit, in particular in the lid of the control unit.

Preferably, the control unit is periodically connected to at least one of the servers via a telephone or computer communication network, in particular of Internet-type.

Preferably, the control unit further comprises a transmission means for sending acoustic signals, in particular of DTMF-type, to a telephone unit, in particular a mobile phone, connected to the server via a telephone and/or computer communication network.

Thus, from inside the vehicle, the motorist can use a mobile phone to connect the on-board control unit to the dedicated server.

Preferably, the microprocessor is programmed so that the operation of the control unit is inhibited if the amount of the parking tax stored in the storage area has not been transferred to the server at the end of a predetermined period.

Preferably, the control unit is integrated into an element of the vehicle. The control unit can in particular be installed on the rear face of the central driving mirror of the vehicle, on the rear face of a sun visor, or on the dashboard of the vehicle.

The display screen of the control unit is turned towards the outside of the vehicle. The parking management services can thus verify that the vehicle is parked in compliance with the set parking policies.

Preferably, the components, in particular the microprocessor, memory, and display screen, are powered by a battery and/or a solar cell.

Preferably, the control unit is powered by electrical energy from the battery of the vehicle.

Other characteristics and advantages of the invention will be apparent from reading the description of alternative embodiments of the invention, given by way of an illustrative example and not to be restrictive, and from

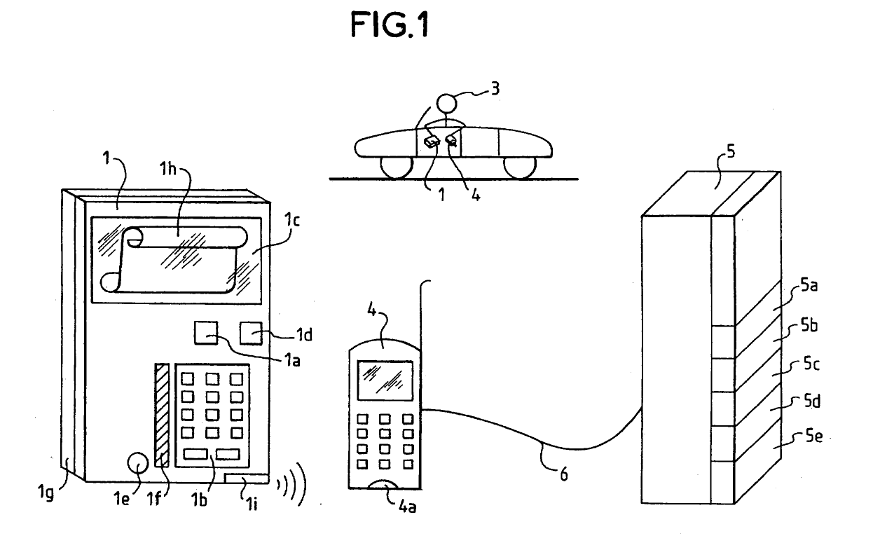

FIG. 1, which schematically represents a variant of embodiment of the invention in the case where the motorist parks in the street,

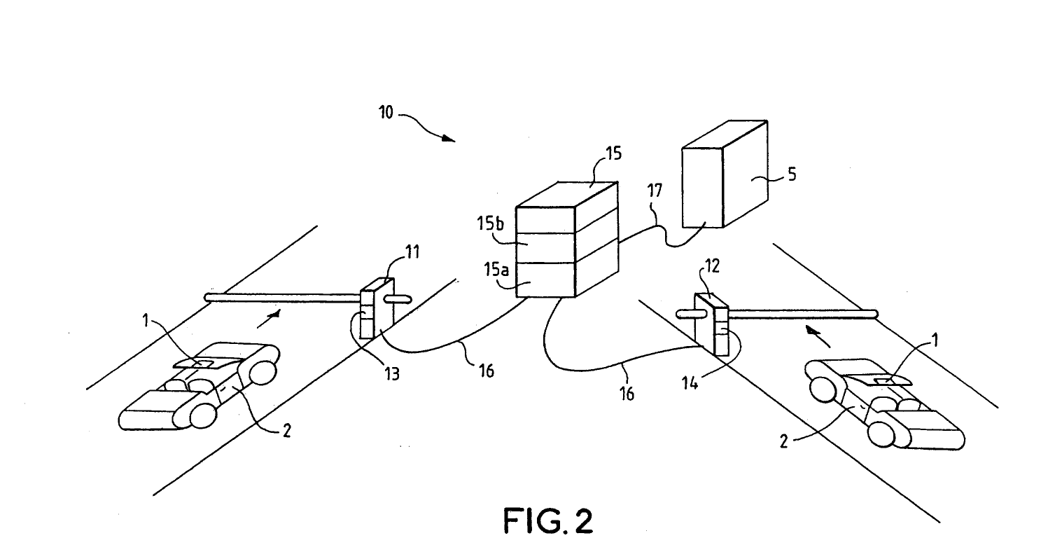

FIG. 2 which schematically represents a variant of embodiment of the invention in the case where the motorist parks in a car-park.

FIG. 1 is described below.

A motorist 3, wishing to park in a town, parks his vehicle 2 at a location reserved for this purpose.

The parking policy of the town involved (rate per hour according to the parking area, free time, maximum time) is predetermined by the authorities.

The motorist 3 has a control unit 1 coming in the form of a box having a size comparable with that of a pocket calculator.

The control unit 1 comprises a storage area id allowing to store the parking policies of the towns. The control unit 1 further comprises a keypad 1b enabling the motorist 3 to activate a drop-down menu 1h on a display screen 1c. Using the keypad 1b, the motorist 3 selects the parking policy of the town where he is, as well as the parameters specific to the parking area where he has parked the vehicle 2.

In practice, it appears that a motorist frequently parks in a small number of cities, in particular that where he works and that where he lives. It happens only infrequently that he has to park in other cities, in particular cities where he is on vacation. Therefore, it will be possible to download the parking policies of the cities from the server 5 (as will be described hereafter) by downloading into the storage area 1d only the parking policies he uses frequently. Moreover, part of the storage area 1d can be reserved for downloading the parking policy of a town where the motorist is going to stay for a little while only. To free up storage space, he will clear the parking policies of the towns where he is no longer going to park.

Also by means of the keypad 1b, the motorist 3 switches on control unit 1 when he starts parking and switches it off when he leaves the parking area. When the control unit 1 is switched on, display screen 1c displays a code corresponding to the parking place enabling the parking management services to check whether the vehicle 2 is parked in compliance with the specified parking policy. In a known way, the operation of the display screen 1c and memory 1d in conjunction with keypad 1b is controlled by a microprocessor 1a.

Depending on the parking policy and the parking time, microprocessor 1a calculates the amount of the parking tax. Thus, only the amount of tax corresponding to the actual parking time is debited to the motorist 3. This amount can be stored in a storage area 1d. The amount will be added to the other amounts previously stored during earlier parking operations. In the case when the control unit 1 further comprises an electronic purse 1g, for each new parking period, the microprocessor 1a debits the amount of tax from the electronic purse 1g. This electronic purse comes in the form of a removable refill lid designed to fit into control unit 1. The value of the purse is predetermined (100 FRF, 200 FRF, . . . ). When the credit of the electronic purse 1g is used up, the motorist buys a new one, in particular from an authorized outlet. The display can also be coupled to a chip lid handling monthly or quarterly residential fixed rates or professional fixed rates (artisans, representatives).

At the end of the parking period, the motorist stops the current deduction by switching the display off. The display keeps the amount of tax in memory as well as the specifications of the parking operation(s) (town, rate per hour, free time, date, parking start and end time, and deducts the totals to be paid).

The components of control unit 1 (microprocessor 1a, memory 1d, display screen 1c) are powered by a battery 1e and/or a solar cell 1f.

According to the invention, the control unit 1 can be connected to a server 5. For this purpose, the control unit 1 comprises a transmission means 1i, for sending DTMF-type acoustic signals to a microphone 4a of a mobile phone 4. The mobile phone 4 is connected to the server 5 via a telephone communication network 6 and the connecting means 5e of server 5.

Periodically, e.g. at the end of the day or at the end of the week, the motorist 3 transfers the data concerning the parking operations he has performed during the period elapsed to the dedicated server. He can also perform this transfer at each parking operation. For this purpose, the display sends a DTMF-type acoustic signal taking said data to the microphone 4a of mobile phone 4. The parking data thus reaches the server 5 where it is uploaded by the uploading means 5b then processed by the computer calculation means 5d. The calculation means 5d make it possible to calculate the worth of the tax to be allocated to the revenue account of the town where the motorist 3 is parking.

The server 5 comprises a storage means 5a for storing the parking policy of the cities and a downloading means 5c for downloading the parking policies into the control unit 1. For this purpose, the data sent by the server 5 is routed through the telephone communication network 6 and reaches the user's mobile phone 4. The acoustic signals sent by the mobile phone 4, carrying data concerning the parking policies, are received by a microphone arranged in the display for this purpose. When the data has been processed by the computer, the parking policies are recorded and/or updated in the storage area 1d of the display.

Thus, from inside the vehicle 2, the motorist 3 can use his mobile phone 4 to connect the control unit 1 to the server 5 either for sending or for receiving data.

As an alternative to buying a new electronic purse 1g, the motorist can refill the electronic purse 1g by downloading an amount agreed upon from server 5 or another server. In this case, the motorist 3 has a user-account, kept by the server 5 or another server. The motorist credits his user-account, in particular by cheque, transfer, or electronic transfer carried out via a communication network, in particular of the Internet type. The server 5, or another server, managing the user-account, deducts from the said user-account the appropriate sum downloaded into the electronic purse 1g.

The motorist 3 can also refill the electronic purse 1g of the control unit 1 by means of a transfer card. The transfer card can in particular take the form of a credit card. The transfer card comprises a storage area containing data corresponding to an amount of credit. It also comprises coupling means of the galvanic type or contactless (for example by induction). These coupling means are designed, in a known way, to transfer data to the electronic purse 1g of the control unit (in the case, the amount of credit contained in the storage area). The transfer card further comprises a microprocessor managing the transfer of the amount of credit contained in the transfer card to the electronic purse 1g of the control unit 1. In order to refill the transfer card, the motorist 3, who possesses a bank account associated with the transfer card, inserts the transfer card into a bank terminal, in particular an automatic cash distributor. In a known way, the bank terminal debits the motorist's 3 bank account by the sum corresponding to the new amount of credit. The transfer card can be used, in a known way, to transfer to the server 5, via the bank terminal, the data corresponding to the parking used by the motorist 3 during the previous period.

The motorist 3 can also refill the electronic purse 1g of the control unit 1 by means of a business card, in particular from an authorized outlet or in a petrol station. The business card has a face value corresponding to several times the face value of the electronic purse 1g of the control unit 1. The business card comprises a storage area containing data corresponding to the face value. It also comprises coupling means of the galvanic type or contactless (for example by induction). These coupling means are designed, in a known way, to transfer data to the electronic purse 1g of the control unit (in the case, account refill units). The business card further comprises a microprocessor managing the transfer of account units contained in the business card to the electronic purse 1g of the control unit 1. For his part, the motorist 3, who has thus refilled his electronic purse 1g, settles the cost of the refill by paying the authorized outlet or garage attendant in cash and/or by cheque and/or by bank card. When the business card has run out the authorized outlet or garage attendant acquires another one, in particular from the manager of the server 5 or from an entity in charge of allocating the amount of taxes due to the revenue budget of the town where the motorist 3 has parked.

The microprocessor 1a of control unit 1 is programmed so that the motorist 3 can only use it if he has performed a data transfer to the server 5 at the end of a determined period of time. In other words, control unit 1 cannot be used until the motorist transfers the sum due for his parking tax. The microprocessor 1a of control unit 1 can also be programmed so that the control unit 1 cannot be used when the amount of the parking tax to be transferred exceeds a predetermined amount.

For connecting to server 5, the motorist can also use a telephone unit, such as a house phone.

Link types other than DTMF links can be used between the control unit and a telephone unit for connecting the control unit 1 to the server 5 via the telephone communication network 6. In particular, it is possible to use in both directions:

a direct, series or parallel wire link,

a modem wire link,

a contactless link via infrared technology,

a contactless radiofrequency link

a contactless magnetic induction link.

Therefore, whatever the town where he may be (in as far as it has approved said system), the user does not have to leave the vehicle to pay the parking tax. He only pays the parking actually consumed. For the cities, the revenue allocation is done on the objective basis of the use of its thoroughfares. It is not necessary to proceed to a revenue sharing between the town where the refill was bought and the town where the parking streets were used.

According to a variant embodiment of the invention, the control unit 1, which comes in the form of a box of a size comparable to that of a pocket calculator, is integrated into an element of the vehicle 2 of the user 3. The control unit 1 can thus be installed on the rear face of the central driving mirror of the vehicle 2. In this case, the display screen 1c of the control unit 1 is turned towards the outside of the vehicle to allow the management parking services managing to verify that the vehicle 2 is parked in compliance with the rules for the set parking policy.

The control unit 1 can also be installed on the rear face of a sun visor or on the dashboard of the vehicle 2. In this case also, the display screen 1c of the control unit 1 is turned towards the outside of the vehicle 2. In the case where it is integrated into an element of the vehicle 2, the control unit 1 can advantageously be powered with electrical energy from the battery of the vehicle 2.

FIG. 2 will now be described, showing diagrammatically a variant embodiment of the invention in the case where the motorist 3 stops in a car-park 10. In FIG. 2 the entry and exit are shown for a vehicle 2 in a car-park 10. The motorist uses the control unit 1, described above, to pay a parking tax in the car-park 10. By car-park here, underground paying car-parks are referred to in particular. The car-park 10 comprises an entry barrier 11 and exit barrier 12. According to this embodiment variant, the control unit 1 comprises means 1j for emission and reception, making it possible to emit and receive signals, in particular of the radio-frequency type, Bluetooth, IRDA, magnetic, contactless by infra-red technology, contactless by radio-frequency, contactless by magnetic induction. The car-park 10 comprises a receiver 13, located at the entrance to the parking 10, before the entry barrier 11. The receiver 13 receives signals, in particular of the radio-frequency type, Bluetooth, IRDA, magnetic, contactless by infra-red technology, contactless by radio-frequency, contactless by magnetic induction. The car-park 10 further comprises a transponder 14, located at the exit from the parking 10, before the exit barrier 12. The transponder 14 emits and receives signals, in particular of the radio-frequency type, Bluetooth, IRDA, magnetic, contactless by infra-red technology, contactless by radio-frequency, contactless by magnetic induction. The receiver 13 and the transponder 14 are connected, via a communication network 16, to a control center 15 situated in technical premises of the car-park 10. The control center 15 is connected to the server 5 via a telephone or computer communication network 17. When he enters the car-park 10, the motorist uses his control unit 1 to transmit a first identification signal to the receiver 13. The first identification signal received by the receiver 13 operates the opening of the entry barrier 11. The entry barrier lifts up and the motorist 3 can then park his vehicle 2. The receiver 13 transmits the first identification signal to the control center 15. The control center 15, thanks to memorization storage means 15a, memorizes the first identification signal. When the motorist 3 wishes to drive his vehicle 2 out of the car-park 10, he comes to the exit barrier 12 of the car-park 10. By means of the control unit 1, the motorist 3 transmits a second identification signal to the transponder 14, located at the exit from the parking 10. The transponder 14 transmits the second identification signal to the control center 15. Through calculation means 15b, the control center 15 calculates, depending on the date and time of entry and exit of the vehicle 2, the amount for the parking service due by the motorist 3, in function of the length of stay in the car-park 10. The control center 15, through memorization means 15a, stores the charge for the parking service. The control center 15 transmits 16 the charge for the parking service to the control unit 1 via the transponder 14. The microprocessor 1a of the control unit 1 deducts the sum due for the parking service from the electronic purse 1g of the control unit 1. After deduction, the control unit 1 transmits to the transponder 14, a signal for opening the exit barrier 12. The exit barrier 12 lifts up and the motorist 3 can then leave the car-park 10. Periodically, the control center 15 transmits to the server 5, via the telephone or computer communication network 17, data related to all the parking which has taken place in said car-park 10 during a certain period of time. The server 5 can then proceed with allocating the receipts concerning each car-park.

In the case of the embodiment variant described above, it is the motorist 3 who, by means of the control unit 1 (operating it manually using the keypad 1b or by vocal command) produces the emission, by the control unit 1, of the first identification signal and the second identification signal respectively, upon entering and exiting the vehicle 2. In another embodiment variant, the emission of the first identification signal and the second identification signal, by the control unit 1, can be activated by signals coming from the terminals located at the entry and the exit of the car-park 10 and detecting the presence of the vehicle 2. In the case of this latter embodiment variant, the motorist 3 has no longer any need to intervene. The opening of the entry 11 and exit 12 barriers is carried out automatically after detection of the vehicle 2 and emission of the first identification signal and the second identification signal by the control unit 1.

1. Method for paying and allocating the charges due to service providers for services for parking vehicles (2), in particular service providers offering a parking service in open areas, for example in town in the street and/or service providers offering a parking service in enclosed areas, for example in a car-park (10); said vehicles being used by motorists possessing control units (1), comprising data representing a prepaid quantity for parking services and/or authorization of parking services; said method comprising the following steps:
activating said control unit (1) at the beginning and at the end of the parking time,
calculating, in function of the parking time, the amount of the parking service.
storing said amount in a memory area (1d),
collecting by means of a dedicated server (5) the charges due for said parking service and allocating this sum to the service provider of the parking concerned.

2. Method according to claim 1 in which said method is more particularly intended for the payment and allocation of parking taxes for vehicles, in particular in the street; the parking policies of the towns concerned, in particular the hourly rate according to the parking areas and/or the non-paying time and/or the authorized maximum time, being pre-determined, said method comprising the following steps:
storage of all or part of said parking policies in a memory (1d) located in a control unit (1) on-board said vehicle,
selecting by means of a control device (1b) of said control unit (1), in particular a control device (1b) activating a drop-down menu (1h), the parking policy of the town where the vehicle is parked together with, in the case where the parking policy varies depending on the parking area, the parameters specific to said parking area,
displaying by means of a display screen (1c) of said control unit (1) a code corresponding to the parking place, in particular the name of said town, as well as the data enabling the parking management services to check whether the vehicle is parked in compliance with the specified parking policy,
activating said control unit (1) at the beginning of the parking period and deactivating said control unit (1) at the end of the parking period,
calculating the amount of the parking tax depending on the parking time,
storing said amount in a memory area (1d) of said control unit (1)
collecting by means of a dedicated server (5) the amount of said tax and allocating this sum to the revenue account of the parking town,
(so that only the amount of tax corresponding to the parking time is debited to the driver of the vehicle and that this amount is allocated to the town concerned).

3. Method according to claim 2 in which said control unit (1) is activated and deactivated manually.

4. Method according to one or the other of claims 2 or 3 in that it comprises:
the step of deducting the amount of said tax from an electronic purse (1g) contained in said control unit (1).

5. Method according to claim 4, wherein said electronic purse (1g) is removable.

6. Method according to claim 4, said method comprising the following steps for refilling said electronic purse (1g):
storing, in a memory area of a transfer card, data corresponding to an amount of credit,
coupling, via coupling means in particular without contact, said transfer card to said electronic purse (1g) of said control unit (1),
transferring, via said coupling means, to the electronic purse (1g) of said control unit, data in particular refill account units;
said transfer of account units being in particular managed by means of a microprocessor.

7. Method according to any one of claims 2 to 6 in which it also comprises:
the step for connecting periodically said control unit (1) to said server (5) to collect the amount of said taxes.

8. Method according to any one of claims 2 to 7 in which it also comprises:
the step for periodically connecting said control unit (1) to said server (5) or another server, for downloading the parking policies and/or their modifications.

9. Method according to any one of claims 4 to 8 in which it also comprises:
the step for connecting said control unit (1) to said server (5) or another server, for downloading said electronic purse (1g) with an appropriate sum.

10. Method according to claim 9; said server (5) or said other server managing a user-account credited, in particular by cheque, transfer, electronic payment carried out via a communication network, in particular of the Internet type; said server (5) or said other server, deducting from said user-account said appropriate amount downloaded into said electronic purse.

11. Method according to any one of claims 7 to 10 also comprising, to connect periodically said control unit (1) to said server (5) or said other server,
the step for establishing a telephone, radiotelephone or Internet-type link between said control unit (1) and said server (5).

12. Method according to claim 11 also comprising, to establish said connection:
the step for sending acoustic signals, in particular of the DTMF-type, between said control unit (1) and telephonic equipment, in particular a mobile phone (4), connected to said server (5) via a telephone and/or computer communication network (6),
(so that from inside the vehicle, the motorist can use a mobile phone to connect said on-board control unit to the dedicated server).

13. Method according to any one of claims 1 to 12; said method being intended in particular for paying and allocating, to service providers, the charges due for parking services for vehicles (2), said parking services being in an enclosed space, in particular in a car-park (10), said car-park (10) comprising an entry barrier (11) and an exit barrier (12), said method comprising the following steps:
for the motorist (3), entering said car-park (10) to emit a first identification signal, to a receiver (13) located before said entry barrier (11), by means of said control unit (1), said first signal received by said receiver (13) operating the opening of the entry barrier (11),
(so that the motorist can park his vehicle);
said method further comprising the following:
the step for said receiver (13) to transmit (16) said first signal to a control center,
the step, for the motorist (3) leaving said car-park (10), to emit to a transponder (14) located before said exit barrier (12), by means of said control unit (1), a second identification signal,
the step, for said responder (14), to transmit (16) said second signal to said control center,
the step, for said control center (15), to determine, from the first and second identification signals, the dates of entry and exit and the times of entry and exit of the vehicle (2),
the step, for said control center (15), to calculate (15b) the amount due for the parking service by the motorist (3), depending on the length of stay in the car-park (10),
the step, for said control center (15), to store the amount due for the parking service by the motorist (3),
the step, for said control center (15) to transmit (16) the amount of the parking service to said control unit (1), via the transponder (14),
the step, for said control unit, to deduct the charges for the parking service from an electronic purse (1g) contained in said control unit (1),
the step, for said control unit (1), to emit, after deducting the sum due for the parking service from said electronic purse (1g) to said transponder (14), a signal to open the exit barrier (12),
(so that the motorist can drive his vehicle out of the car-park),
the step, for said control center (15), to transmit to said server (5), via a telephone or computer communication network (17), data relative to all the parking carried out in the said car-park (10), during a certain time period,
(so that the server can proceed with allocating receipts for each car-park).

14. System for paying and allocating to service providers, the sum due for parking services for vehicles (2), in particular to service providers offering a parking service in an open area, for example in the streets of a town, and/or service providers offering a parking service in an enclosed area, for example a car-park (10); said vehicles (2) being used by motorists possessing control units (1), comprising data representing a prepaid quantity of parking services and/or authorization for parking services; said control units (1) comprising a control device in particular a keypad, able to be operated by said motorist at the beginning and the end of the parking period;
said system comprising:
calculation means for calculating the charges for the parking service depending on the length of stay,
storage means for storing said charge in a memory area (1d),
remote data collection means for collecting by means of a dedicated server (5) the sum due for said parking service and allocating it to the parking service provider concerned.

15. System according to claim 14 in which said system is more particularly intended for payment and allocation of vehicle parking taxes, especially in the street; the parking policies of the towns concerned, in particular the hourly rate according to the parking zones and/or the free time and/or the maximum length of time allowed, being predetermined;
said system comprising:
a control unit (1) on-board said vehicle; said control unit (1) comprising:
storage means for memorizing said parking policies in a memory (1d),
a control device, in particular a keypad (1b) activating a drop-down menu (1h),
for selecting the parking policy of the town where the vehicle is parked and, in case the parking policy varies depending on the parking area, the parameters specific to said parking area,
for activating said control unit (1) at the beginning of the parking period and deactivating it at the end of the parking period,
a display screen (1c) for displaying a code corresponding to the parking place, in particular the name of said town, as well as the data enabling the parking management services to check whether the vehicle is parked in compliance with the specified parking policy,
a microprocessor (1a) for calculating the amount of the parking tax depending on the parking time and for storing said amount in a storage area (1d) of the control unit (1), said system further comprising:
a dedicated server (5) for periodically collecting the amount of said tax and for allocating the relevant amount to the revenue account of the town where the vehicle is parked,
(so that only the amount of tax corresponding to the parking time is debited to the driver of the vehicle and this amount is allocated to the town concerned).

16. System according to claim 15 in which the microprocessor (1a) deducts the amount of said tax from an electronic purse (1g) located in said control unit (1).

17. System according to one or the other of claims 15 or 16, in which said electronic purse (1g) is located in a removable part of said control unit (1), in particular in the lid of said control unit (1).

18. System according to any one of claims 15 to 17 also comprising:
one or several dedicated servers (5) for downloading the parking policies and/or their modifications and/or for downloading an appropriate amount into said electronic purse (1g).

19. System according to any one of claims 15 to 18 in which said control unit (1) and said servers (5) are connected, via a telephone or computer network (6), especially of the Internet type,
(so that it is thus possible to collect periodically the sum of the parking taxes stored in said control unit and to allocate the amount to the revenue account of the parking town, so that it is then possible to download the parking policies and/or their modifications into the memory of said control unit, in such a way that it is thus possible to refill the electronic purse).

20. System according to any one of claims 15 to 19, said system also comprising emission means (1i) for emitting acoustic signals, in particular of the DTMF type, between said control unit (1) and a telephone equipment, especially a mobile phone (4), connected to said servers (5) via a telephone and/or computer communication network (6),
(so that the motorist can use a mobile phone from inside his vehicle to connect said on-board control unit to said dedicated servers).

21. System according to any one of claims 15 to 20, said control unit being integrated in an element of the vehicle (2), said control unit being installed in particular on:
the rear face of the central driving mirror of the vehicle (2),
the rear face of a sun visor,
the dashboard of the vehicle (2),
the display screen (1c) of said control unit (1) being turned towards the outside of the vehicle (2),
(so that the parking management services can verify that the vehicle (2) is parked in compliance with the set parking policy).

22. System according to any one of claims 15 to 21 such that the components of said control unit (1), especially the microprocessor (1a), the memory (1d), the display screen (1c), are powered by a battery (1e) and/or a solar cell (1f).

23. System according to any one of claims 15 to 21 in which said vehicle is powered by electrical energy from a battery, said control unit (1) being powered by electrical energy from said battery.

24. System according to any one of claims 14 to 23, said system being intended more particularly to paying and allocating, to service providers, the sums due for parking services for vehicles (2), said parking services being in an enclosed area, in particular in a car-park (10);
said method comprising:
at least one entry barrier (11) and at least one exit barrier (12) located respectively at the entrance and the exit of said car-park (10);
at least one receiver (13) receiving signals, located at each entry to said car-park (10), before the entry barrier (11),
at least one transponder (14) emitting and receiving signals, located at each exit from said car-park (10), before the exit barrier (12);
said control unit comprising:
means of emitting and receiving (1j) in order to transmit a first identification signal to said receiver (13) when said vehicle (2) enters said car-park (10),
means of emitting and receiving (1j) to transmit a second identification signal to said transponder (14) when said vehicle (2) leaves said car-park (10),
a control device, especially a keypad, to activate the emission of said first and said second signal by said means of emission and reception (1j);
said first signal received by said receiver (13) operating the opening of the entry barrier (11),
(so that the motorist can then park his vehicle);
said system also comprising:
a control center (15), connected (16) to said receiver (13) and to said transponder (14), receiving said first signal and said second signal;
said control center (15) comprising:
processing means for determining, from said first and said second identification signal, the dates of entry and exit and the times of entry and exit of the vehicle (2),
calculation means (15b) for calculating the charges due by the motorist (3) for the parking service, depending on the length of stay in the car-park (10),
memorization means (15a) for storing the charges for the parking service due by the motorist (3),
transmission means for transmitting the charges for the parking service to said means of emission and reception (1j) of said control unit (1), via said transponder (14);
said control unit also comprising:
an electronic purse (1g)
a microprocessor (1a) comprising means for deducting the sum due for the parking service from said electronic purse (1g);
said means of emission and reception (1j) of said control unit emitting a signal for opening the exit barrier (12), to said transponder (14), after deducting the charge of the parking service from said electronic purse (1g),
(so that the motorist can then drive his vehicle out of the car-park),
said control center (15) transmitting to said server (5), via a telephone or computer communication network (17), data relative to all the parking carried out in said car-park (10), during a certain time period,
(so that the server can proceed with allocating receipts for each car-park).

25. Server (5) intended to be operated to pay and allocate to service providers the charges due for parking services for vehicles (2), in particular service providers offering a parking service in open areas, for example in town in the street and/or service providers offering a parking service in enclosed areas, for example in a car-park (10); said vehicles (2) being used by motorists possessing control units (1), comprising data representing a prepaid quantity for parking services and/or authorization for parking services; said control units (1) comprising a control device, in particular a keypad, to be operated by said motorist at the beginning and the end of the parking period;
said server (5) comprising means for remote data collection to collect the charges due for a parking service and means for allocating the sum to the parking service provider concerned; said parking service having been calculated depending on the length of parking and stored (1d) in a memory area.

26. Server (5) according to claim 25; said server being more particularly intended to be operated for the payment and allocation of parking taxes for vehicles, in particular in the street; the parking policies of the towns concerned, in particular the hourly rate according to the parking areas and/or the non-paying time and/or the authorized maximum time, being pre-determined, said taxes being calculated by control units on-board the vehicles;
said server comprising:
means (5a) of memorization for storing said parking policies in a memory,
means (5b) of remote data collection for collecting from each control unit (1) the amount of said taxes, and/or
downloading means (5c) for downloading parking policies into each control unit (1),
calculation means (5d) for calculating the sum of the taxes to be allocated to the revenue account of the town for the parking under consideration.

27. Server (5) according to claim 26 comprising connection means (5e) for periodically connecting said server (5) to said control units (1), via a telephone or computer communication network (6), especially of the Internet type.

28. Server (5) according to one or the other of claims 26 or 27 further comprising downloading means (5c) for downloading parking policies and/or their modifications into a memory (1d) of said control unit (1).

29. Server according to any one of claims 25 to 28; said server being more particularly intended for the payment and allocation to service providers, of the sum due for parking services for vehicles (2); said parking services being in an enclosed area, especially in a car-park (10); said car-park (10) being closed by at least one entry barrier (11) and by at least one exit barrier (12); said barriers being located respectively at the entry and at the exit of said car-park (10); said barriers being operated by said motorist at the entry and exit of said vehicle by means of said control unit;
said server (5) being connected via a telephone or computer communication network (17) to control centers (15) associated to the car-parks; said server receiving from each control center data relative to all the parking carried out in said car-park (10) being considered, during a certain period of time; said control centers (15) comprising calculation means for calculating the charges due for the parking service by each motorist (3) depending on the length of stay in said car-park (10) being considered; said length of parking time being determined from signals emitted by said control unit (1) at the entry and the exit of each of said vehicles (2) of said car-park (10); said signals being transmitted to said control center.

30. Control unit (1) intended to be on-board a vehicle for paying and allocating the parking taxes of said vehicle, especially in the street; the parking policies of the towns concerned, in particular the hourly rate according to the parking areas and/or the non-paying time and/or the authorized maximum time, being pre-determined,
said control unit (1) comprising:
memorization means (1d) for storing said parking policies in a memory,
a control device, especially a keypad (1b) activating a drop-down menu (1h),
for selecting the parking policy of the town where the vehicle is parked and, in the case where the parking policy varies depending on the parking area, the parameters specific to said parking area,
for activating said control unit (1) at the beginning of the parking period and deactivating it at the end of the parking period,
a display screen (1c) for displaying a code corresponding to the parking area, in particular the name of said town, as well as data allowing the parking management services to verify whether the vehicle is parked in compliance with the set parking policy,
a microprocessor (1a) for calculating according to the length of parking the amount of parking tax due and for storing said sum in a memory area of said control unit (1),
connection means (1i) for linking said control unit (1) to one or several distant dedicated servers intended (i) to collect the amount of said tax and to allocate the sum to the revenue account of the town of parking and/or (ii) to download the parking policies and/or their modifications and/or (iii) to refill the electronic purse (1g).

31. Control unit (1) according to claim 30 in which the microprocessor (1a) deducts the amount of said tax from an electronic purse (1g) contained in said control unit (1).

32. Control unit (1) according to claim 31 in which said electronic purse (1g) is located in a removable part of said control unit (1), especially in the lid of said control unit (1).

33. Control unit (1) according to any one of claims 30 to 32 periodically connected to at least one of said servers via a telephone or computer communication network (6), especially of the Internet type.

34. Control unit (1) according to claim 33; said control unit (1) also comprising means (1i) of emission for emitting acoustic signals, in particular of the DTMF type, to a telephone unit, especially a mobile phone (4), connected to said server (5) via a telephone and/or computer communication network,
(so that from inside the vehicle, the motorist can use a mobile phone for connecting said on-board control unit to the dedicated server).

35. Control unit (1) according to any one of claims 30 to 34; said microprocessor (1a) being programmed in such a way that the operation of said control unit (1) is inhibited if the amount of the parking tax stored in the memory area (1d) has not been transferred to the server (5) after a predetermined period.

36. Control unit (1) according to any one of claims 30 to 35; said control unit being integrated into an element of the vehicle (2); said control unit being installed in particular on:
the rear face of the central driving mirror of the vehicle (2),
the rear face of a sun visor,
the dashboard of the vehicle (2);
the display screen (1c) of said control unit (1) being turned towards the outside of the vehicle (2),
(so that the parking management services can verify whether the vehicle (2) is parking in compliance with the set parking policy).

37. Control unit (1) according to any one of claims 30 to 36 in which the components, especially the microprocessor (1a), the memory (1d), the display screen (1c), are powered by a battery (1e) and/or a solar cell (1f).

38. Control unit (1) according to claim 36; said vehicle being powered by electrical energy from a battery; said control unit (1) being powered by electrical energy from said battery.
